(19) United States
(12) Patent Application Publication
(10) Pub. No.: US 2026/0151804 A1
(43) Pub. Date: Jun. 4, 2026

(54) Method and apparatus for the process-integrated cleaning of pipelines or systems of technical installations by means of modulating compressed-gas pulses

(71) Applicant: Hammann Engineering GmbH, Annweiler am Trifels (DE)

(72) Inventors: Hans-Gerd Hammann, Annweiler am Trifels (DE); Sebastian Immel, Reilingen (DE); Norbert Klein, Grosbliederstroff (FR)

(21) Appl. No.: 18/251,488

(22) PCT Filed: Sep. 7, 2022
(86) PCT No.: PCT/EP2022/074854

§ 371 Date: May 2, 2023

(30) Foreign Application Priority Data
Nov. 29, 2021 (EP) 21210953.2

(51) Int. Cl. B08B 9/032

(52) U.S. Cl. CPC B08B 9/0328; B08B 9/0325; B08B 9/0326; B08B 2209/032

(57) ABSTRACT

A method and apparatus for cleaning pipelines or systems by way of a pipeline section partially filled with flushing liquid being subjected to modulating compressed-gas pulses to form alternating blocks of liquid and blocks of gas, which, for the purpose of removing deposits from the pipeline walls, are driven in a pulse-like manner through the pipeline along a flushing section from an infeed location to a discharge location. A preliminary section may be arranged upstream of the flushing section, for the purpose of accelerating the liquid volume in the pipeline or the system. The preliminary section is partially filled with the flushing liquid and is dimensioned, in respect of its geometry, diameter and/or length, such that, when subjected to a compressed-gas mixture, the blocks of liquids can form fully within the preliminary section so as to fill the cross section of the following flushing section as they pass through it.

### TECHNICAL FIELD

The present invention relates to a method and a device for cleaning pipes or systems by impinging modulating pressurized gas impulses to a pipe section partially filled with flushing liquid in order to develop alternating liquid blocks or gas blocks, which are driven by pulses along a flushing section from a feed point through the pipe to a discharge point in order to remove deposits on the pipe walls.

### STATE OF THE ART

Methods and systems for cleaning pipes or systems by means of pressurized air impulses are sufficiently well-know. DE 102 04 737 A1 describes a method and a device for flushing a pipe, in particular, a drinking water supply pipe. Flushing and cleaning are performed by generating flushing water flows within the pipe and by introducing gaseous nitrogen into the flow at predetermined intervals in order to subdivide the flow into alternating consecutive water and nitrogen bubbles.

DE 35 02 969 A1 describes a method and a device for cleaning a pipe using simultaneously-introduced impulses of a liquid or a gas, whereby the impulses are mixed into overall impulses, which intermittently pass through the pipe. In the process, the impulses of the liquid or gas are broken down into individual impulses.

DE 37 22 549 A1 describes a device for flushing and cleaning a pipe, in which a shut-off valve and a non-return valve each are arranged consecutively within the air feed line and the flushing-liquid line, and in which a pressurized compensation vessel is arranged within the air feed line after the non-return valve.

DE 44 38 939 A1 describes a method and a device for cleaning drinking water pipes and for flushing networks of drinking water pipes. Here, a flushing section is set up between a first tap used as a feed point for compressed air and a second tap used as a discharge point for the flushing water, which is flushed by the flowing water flow and impinged with flushing pressure higher than the mains pressure in several intervals by supplying a volume of compressed air via a compressed air line connected to the feed point.

The EP patent 2 674 228 B1 describes a method to remove deposits and/or biofilms in a pipe, in which at a feed point before the flushing section a pipe, which is at least partially filled with liquid, is impinged with a gas or gas mixture by introducing pressure impulses. In a preparatory stage, the pipe is partially emptied to a remaining liquid quantity by means of the gas or gas mixture. This is followed by a modulating pressurized gas supply through one or more pressure impulses with high pressure, resulting in the development of mini water blocks in the pipe, which are driven through the pipe with high speed. The pressurized gas supply is directly readjusted with the same or a higher pressure after a temporary decline. Thereby other water blocks are formed, which collide with high speed with the preceding mini water blocks, which thus obtain supplementary propulsion.

In one embodiment of the EP patent 2 815 816 B1 this method has been optimized, dividing cleaning phase into an initial rest phase, a retraction phase and an impulse phase. In the initial rest phase, the flushing section is filled with liquid and then partially emptied by introducing a gas or a gas mixture during the retraction phase. In the subsequent impulse phase, the flushing section is impinged with the gas or gas mixture in several sequences of at least two impulses. At the end of a sequence and until the start of the following sequence, a pause phase is introduced in which pressure is reduced and the flushing section is partially filled.

These methods are generally designed for mobile application, the aim of which is to remove deposits or biofilms in municipal pipes, where DNs (nominal diameters) between DN80 and DN200 are usual. In addition, the methods are used for cleaning transport pipes, untreated water or fountain pipes, and drinking water installations in buildings. In addition, it is also possible to effectively clean industrial facilities, for example heat exchangers, with the pressure impulse method using mobile cleaning devices. The principle of the impulse flushing method is always the same. First of all, it is necessary to determine cleaning sections with a feed point and a discharge point. The cleaning sections are usually determined by shut-off elements such as stop valve. The feed points and discharge points are, for example, hydrants in a drinking water pipe. At the feed point there is a device for impinging compressed air, and at the discharge point there is a discharge box or another device for releasing the compressed air. For cleaning, the stop valves are closed and the hydrants at the feed points and discharge points are opened.

The subsequent cleaning takes place in several phases. First, the cleaning section is set to a partially filled state by throttling the feed point stop valve and carefully impinging compressed air from the unit. During this process, the pressure always remains below the operating pressure of the pipe to be cleaned. Then the actual cleaning begins. In order to do so, compressed air gets metered by a control software of the control unit and is driven into the partially filled pipe section. There, the air can expand immediately and thus form cleaning-effective packages of water and air blocks in an impulse-like manner.

The effectiveness of cleaning primarily depends on the speed at which these packages are driven through the pipe. In the impulse flushing method, the velocities are frequently above 15 m/s, often clearly above 20 m/s. Acceleration effects have a decisive influence on the effectiveness of the cleaning. For developing blocks, the surface of the water resting in the pipe's invert level is accelerated within a split second. Acceleration and velocity together cause a shear stress which in scale is higher in the impulse flushing method than in a simple water flushing.

Hygienic and hydraulic aspects play a role in the application of the impulse flushing method. The hygienic aspect always has priority when cleaning a drinking and untreated water pipe. From a hydraulic point of view, deposits in a pipe or a system (e.g., a heat exchanger) also increase the energy requirement for water transport. Deposits compromise the hydraulics of pipes. The energy required to transport the water and thus the power demand of the pumps increase when the cross-section of the pipe is narrowed due to the deposits. Due to the deposits in the pipe and hence the narrowing of the cross-section, the pump pressure increases, while at the same time the volume flow (the flow rate) decreases. The efficiency of a pump also decreases. A decreasing volume flow (flow rate), in turn, means longer pumping times for the same volumes or amounts of water. These are enormous disadvantages.

A thorough cleaning of drinking water pipes or other systems also requires the decommissioning of pipe sections. When considering the industrial application of the impulse flushing method in the context of a process-integrated cleaning of industrial production facilities, a mobile application of the impulse flushing method is quite time-consuming and facility downtimes can occur. Even though mobile cleaning systems allow a location-independent use of several buildings or facilities, automated stationary cleaning systems would offer considerable advantages when changing batches or products.

In facilities of the paint and coatings industry, pigging technology is often used for the maintenance of pipes. This involves flushing non-piggable areas, such as pumps or branches, with water or other aqueous media. However, these methods are not suitable for completely removing product residues from the systems. In addition, flushing generates significant quantities of wastewater and corresponding recycling costs. Product residues in the systems, in turn, harden over time and form persistent deposits, which significantly increases the cleaning effort. Facility downtimes and corresponding financial losses are the result. New thresholds for biocides or preservatives pose further challenges for facility operators in terms of industrial hygiene.

In industrial production facilities, in turn, chemicals are often produced discontinuously in batch operation when small product quantities are required. Downtimes always mean economic losses, because cleaning the pipes in order to prepare them for the next production batch is very complex, especially when using a mobile cleaning solution, i.e., not a cleaning solution which is stationarily integrated in the production facility. Furthermore, these facilities do not only comprise pipes, but also complex structures integrated in the system, such as pumps, heat exchangers or controlling instruments. Often, entire facilities have to be dismantled and reassembled after cleaning, which is very difficult and time-consuming.

### DESCRIPTION OF THE INVENTION

Against this background, it is the object of the present invention to provide an improved method and device for cleaning pipes and systems, which enable a fully-integrated and automated cleaning of a process facility.

This object is solved by a method with the features according to claim 1 and a corresponding device for carrying it out. Preferred embodiments can be found in the subclaims.

The method for cleaning pipes and system according to the invention is an impulse flushing method and is based on impinging modulating pressurized gas impulses to a pipe section partially filled with flushing liquid (e.g., water or process liquid) tin order to develop alternating liquid blocks and gas blocks, which are driven in pulses along a flushing section from a feed point through the pipe to a discharge point for removing deposits on the pipe walls.

The term “pressurized gas” usually comprises a compressed gas or gas mixture. The term “gas” comprises not only pure gases, but also gas mixtures. Preferably, pressurized air is used as pressurized gas in the present invention. However, other (inert) gases or gas mixtures can also be used as pressurized gas, for example argon, nitrogen or carbon dioxide. The level of pressure is preferably between 3 and 8 bar.

According to the invention, it is now intended that a pre-run section for accelerating the liquid volume in the pipe or the system is arranged upstream of the flushing section, the pre-run section being partially filled with the flushing liquid and regarding its pipe geometry, its pipe diameter and/or its pipe length being dimensioned in a way that, when impinging a pressurized gas mixture (preferably compressed air), the liquid blocks within the pre-run section can be completely developed in order to travel through the pipe cross-section of the subsequent flushing section in a pipe-filling manner. When water or an aqueous medium is impinged to the pipe or the system at the feed point, the liquid blocks that develop are water blocks.

According to the invention, the term “flushing section” refers to the pipe section or system section to be cleaned of the pipe or system to be cleaned. The flushing section thus corresponds to the cleaning section.

The term “flushing liquid” refers to the medium used for flushing or cleaning, for example water, process liquid or product liquid.

The term “system” refers to built-in components or branches that are usually associated with a change in pipe diameter. Examples of these components or systems are pumps, heat exchangers, fittings, filters, pumps, sieves, distributors, vessels, gas scrubbers, reactors, or hydrogenation plants. This list is not limiting and includes further components that are part of a modern product pipe system. The “pre-run section” describes a pipe section that is located upstream of the actual flushing section or cleaning section.

The method according to the invention is characterized in that the energy required for cleaning is significantly reduced compared to the conventional impulse flushing methods. Furthermore, the efficiency of the method is improved by arranging the pre-run section upstream of the actual flushing section. The pre-run section for the liquid blocks, which is arranged upstream of the flushing section, ensures that the liquid blocks can develop within the pipe or system section in order to fill the pipe until the flushing section begins. The pre-run section thus acts as an acceleration section for the developing liquid blocks and ensures that these are completely developed in the cleaning section before the flushing section begins.

Preferably, a partial filling of the pre-run section with a liquid volume of approximately 10 to 30% of the pipe diameter is sufficient. Cleaning gets particularly complicated if there are built-in components in the system, such as heat exchangers, pumps or filters. In this case, the flushing section has to be precisely defined, taking into account the pipe topography, i.e., among other things, the pipe diameter, cross-sections and nominal values of the cleaning section. If a pipe diameter changes, individual flushing sections are defined and the individual cleaning sections are shut off accordingly or disconnected from the rest of the pipe system. This is preferably done by valves, stop valves or shut-off valves. Preferably, built-in components such as pumps or filters are part of a separate flushing section within the production facility. Furthermore, when using pumps or filters, forward and backward cleaning is preferably carried out in order to increase efficiency. Forward and backward cleaning means with or against the prevailing flow direction of the process medium during operation.

According to the invention, the terms “flushing” and “cleaning” are used synonymously and either describe a flushing or a cleaning of a pipe or a system, whereby both can be mutually dependent. Thus, a cleaning section is always a flushing section and vice versa. Preferably, the pre-run section, regarding its diameter or length, is dimensioned in a way that, when impinged with a pressurized gas mixture, alternating gas and liquid blocks develop in a pipe-filling manner until the end of the pre-run section and before the beginning of the flushing section. The existing deposits on the pipe wall or product residues are removed by developing shearing forces and wall shear stress.

In a preferred embodiment, the pressurization at the pre-run section and the amount of flushing liquid are adjusted in a way that the flushing liquid is accelerated in an impulse-like manner within the pre-run section, but still before the flushing section in order to develop pipe-filling liquid blocks with a flow velocity of at least 15 m/s.

In a further preferred embodiment, it is intended that the pre-run section runs upwards. Preferably, at least segments of the pre-run section are arranged upwards with an incline of >0° in relation to the horizontal level. The course of the subsequent flushing section is then rather secondary; it can run in any angular range. Preferably, the angular range of the pre-run section is between >0° and <90° in relation to the horizontal level, i.e., with an upward incline. The pre-run section can also comprise different pipe sections with different incline angles. Due to the incline angle of the pre-run section, the flushing liquid can accumulate in the invert level of the partially filled pipe section of the pre-run section. This ensures that the liquid block develops efficiently when being pressurized and can be accelerated to the requested velocity.

Furthermore, it is preferably intended that the volume and the length of the pre-run section are conditioned by the DN (nominal diameters) and topography of the subsequent flushing section. Preferably, the length of the pre-run section is at least 10 times the pipe diameter of the flushing section. Preferably, the diameter of the pre-run section should be at least half the diameter of the flushing section.

In complex production facilities, cleaning by means of the method according to the invention is largely independent of the geometry of the facility, as in accordance with the pipe topography or the system topography, the flushing section is always defined by considering nominal values such as geometry, length, diameter and/or dimension of individual pipe sections or built-in parts of the system. If necessary, corresponding pipe or system sections are disconnected from the flushing section. In the case of a stationary Installation of the device carrying out the method according to the invention, facility components or instruments can remain installed, for example measuring devices for pressure, temperature, mass flow, volume flow or conductivity. This shortens facility downtimes and reduces costs. Moreover, by precisely adjusting the volume of water in the pre-run section, the amount of liquid required for cleaning or product changeover is considerably reduced, resulting in a significant cost reduction.

If available, control instruments or other fittings of the facility are adjusted in a way that they meet the gas and liquid blocks of the cleaning method according to the invention with as little resistance as possible. Instruments such as reactors, heat exchangers or gas scrubbers can be specifically cleaned via the nearest feed points and discharge points. Preferably, the feed point and the discharge point comprise flange connections in order to install the equipment required for pressurization.

Generally, the application of the method according to the invention also makes it possible to determine the extent of the deposits developed during the operating time and removed by means of the impulse flushing method. Preferably, features such as inserted non-woven fabrics for the retention of coarse particles in a decompression box, a turbidimeter of discharged wastewater or even separation measures at corresponding preparation facilities can be considered here. It is also possible to reuse the flushing liquid by means of a targeted circulation management.

Due to the fact that the impulse flushing method according to the invention has been optimized compared to existing methods, even complex industrial production facilities can be cleaned economically. Feed points and discharge points, for example at existing flange connections or already installed shut-off valves with blind flanges, considerably reduce the set-up time. Due to the provided pre-run section, the required alternating liquid blocks and gas blocks are already fully developed in the flushing section and can travel through the pipe and assume their function efficiently, independent of geometry. Due to the surprising realization that arranging a pre-run section upstream of the actual flushing section improves the cleaning success, the method becomes significantly more efficient as it is the case with the common impulse flushing method without a pre-run section. Complex built-in components such as reactors, heat exchangers or gas scrubbers can also be cleaned while staying installed. It is only necessary to ensure that an appropriately dimensioned pre-run section is provided upstream of these components or systems. In this case, the pipe or system is preferably divided into individual cleaning sections that can be disconnected from other pipe or system sections, depending on the nominal diameters.

Preferably, the disconnecting of the cleaning sections is controlled by a control unit. The control unit not only controls the supply of pressurized gas, but also the supply of the flushing liquid. Furthermore, it controls the volume flow, the quantity and/or the pressure during the flushing liquid supply. By monitoring and controlling the pressurized gas supply and the flushing liquid supply, the pre-run section can be specifically partially filled with the required amount of liquid.

Typically, the method according to the invention is used for all pipes or systems to be cleaned or flushed, for example for product pipes or systems of process facilities. The cleaning of the pipe or system is preferably carried out in a stationary manner, i.e., process-integrated. In the case of a stationary installation, it is perfectly suited as a CIP (clean in place) method.

In a preferred embodiment, it is intended that a separating unit is arranged at the discharge point, which is configured in a way that product residues are separated from the flushing liquid of the cleaned pipe or the cleaned system. This is because products are often very valuable, so that even discharging minimal amounts would be a loss. The product residues received from the flushing liquid via separation can be recycled and thus increase the added value. Furthermore, in a preferred embodiment, it is intended that the flushing liquid of the separation unit separated from the product residues is transported back to the feed point. This procedure again saves the need for flushing liquid and also avoids its immediate disposal in case of problematic product residues.

In addition to the method, the invention also relates to a device for cleaning pipes or systems by impinging modulating pressurized gas impulses to a pipe section partially filled with flushing liquid in order to develop alternating liquid blocks and gas blocks which are driven in pulses along the flushing section from the feed point through the pipe to the discharge point. The device includes a pre-run section arranged upstream of the flushing section in order to accelerate the liquid volume in the pipe or system into pipe-filling liquid blocks. Preferably, compressed air is used as pressurized gas to form air blocks.

The device preferably comprises a control unit to perform the cleaning in a semi-automatically or fully automatically process-integrated manner, whereby the pipe or the system is divided into individual cleaning sections that can be disconnected from other pipe or system sections, depending on the nominal diameters. The disconnecting is preferably carried out via valves, stop valves or shut-off valves.

### BEST WAY TO CARRY OUT THE INVENTION AND INDUSTRIAL APPLICATION

### EXAMPLES

In the following embodiments, preferred areas of application of the method or device according to the invention are shown. However, the invention is in no way intended to be limited to these areas of application. Nevertheless, it becomes obvious that the method or the device is suitable for being process-integrated into complex process facilities or production facilities in order to carry out CIP cleaning, for example. Due to the semi-automated or fully automated process, batch processes, for example, can be adjusted more quickly, which reduces unnecessary downtimes and thus production losses. In contrast to mobile devices, stationary cleaning devices also provide the opportunity to select shorter cleaning intervals. A subordinate facility control enables cleaning to be integrated into the process. Cleaning is thus an integral part of the production process. Preferably, each cleaning section is assigned with an optimized cleaning program or cleaning parameters for condition-based cleaning. Furthermore, sensors can record measured data in order to monitor the cleaning success. These measuring devices also enable cleaning parameters to be controlled. Devices are also provided, for example, to detect irregularities or malfunctions, for example if there is an insufficient supply of compressed air in the system.

### Process-Integrated Cleaning of Dispersion Paint Production Facilities

In production facilities for emulsion paints, it is common to separate the batches in the pipes by pigging when the product is changed. Pigging is used to maintain the pipes. However, the disadvantage is that there are areas such as pumps or branches where the pigs cannot be used. Therefore, these non-piggable areas have traditionally been flushed with significant amounts of water or other aqueous media. However, these flushing methods and pigging technology are not suitable for completely removing product residues from the systems. In addition, flushing generates significant amounts of wastewater and corresponding recycling costs. High water withdrawals are also more difficult to justify in hot summer months. Moreover, product residues harden in the systems and form persistent deposits, which again enormously increases the cleaning effort. The method according to the invention enables condition-oriented cleaning even before these deposits harden. Furthermore, the new thresholds for biocides and preservatives pose further challenges for facility operator in terms of industrial hygiene.

Due to the arrangement of the pre-run section upstream of the flushing section according to the invention, far less flushing liquid is required than in a conventional impulse flushing. In addition, hygienically perfect compressed air is used. This is particularly important if the water polluted by the cleaning process is supposed to be reused for new products, for example. The method and device according to the invention clean systems regardless of geometry, because the air and water blocks adjust themselves accordingly. Thus, even the previously mentioned non-piggable areas such as branches, narrowing or slots can be cleaned effectively.

By defining the flushing section, it is also possible to use chemical additives for the respective cleaning section. This has the advantage that other pipe sections are disconnected from the actual cleaning section and therefore not affected by the measure. A chemical cleaning can be necessary, for example, to completely remove very persistent deposits.

A process-integrated maintenance cleaning does not require chemical treatment if it takes place in short intervals, for example on a daily basis, during a product change. Distributors and fittings ensure that the required raw materials arrive in the intended mixing systems. The position of the fittings is controlled by a central control unit, which also specifies the respective cleaning sections. The control can, for example, take place automatically via a control unit or be predetermined by a control room.

Various cleaning programs are available for cleaning, depending on the requirements or the condition. The standard cleaning of an entire production area takes between 30 and 45 minutes, depending on the area. Furthermore, eco-cleaning can be carried out, in short intervals of only 15 to 20 months, which represents a compromise between time and water requirements and the required cleaning result.

### Batch Operation Applications

In modern production facilities, chemicals are produced discontinuously in batch operation, especially when small product quantities are required. The facilities often contain gas scrubbers or heat exchangers. An installation of the device according to the invention makes it possible to clean the pipes and devices economically with only a few feed points and discharge points. In addition, temperature control circuits can also be cleaned during temperature-controlled reactions. If redundant built-in components are provided, cleaning can always take place during downtimes of the built-in component while the other built-in component is active. It is worth mentioning that the efficiency of the built-in components, for example pumps or heat exchangers, is significantly increased by cleaning in intervals, as existing deposits reduce the cross-section of the pipe.

### DESCRIPTION OF THE DRAWINGS

FIG. 1 shows the connection between deposits in pipes and the energy required for water transport. It can be clearly seen how existing deposits increase the energy requirement, for example in shell-and-tube heat exchangers. Accordingly, the temperature difference in an uncleaned tube bundle is considerably higher than in a cleaned or new tube bundle.

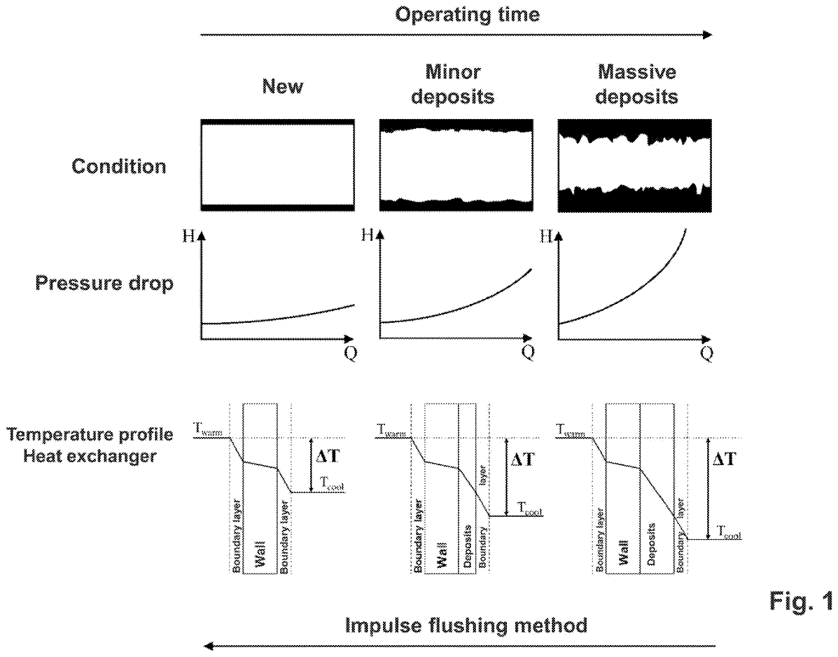

FIG. 2 shows how valves and sensors can be used to control the cleaning process in a process-integrated manner. The flushing section (cleaning section) is part of a system, a pipe, a heat exchanger or a device. An acceleration section (pre-run section) for the modulating pressurized gas impulses with pressure and flushing liquid as supply media is arranged upstream of the actual flushing section. The pre-run section is first precisely partially filled with flushing liquid. In the embodiment displayed, at least segments of the pre-run section run upwards, which can be used to accumulate flushing liquid in the pipe's invert level. Thus, the development of liquid blocks is stronger. The pressurization ensures that the liquid blocks develop in a pipe-filling manner until the beginning of the subsequent flushing section, in order to completely remove deposits or product residues on the surfaces of the flushing section. Thus, cleaning cycles can be minimized or cleaning intervals can be increased.

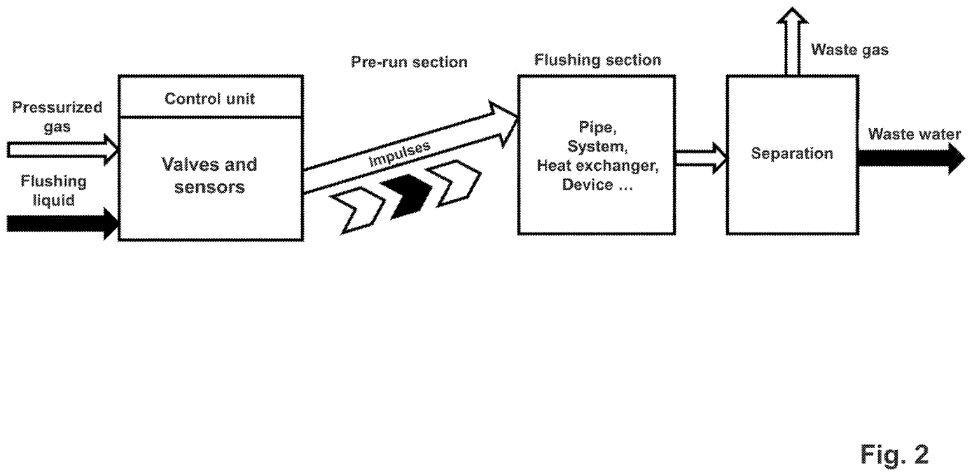

The embodiment also intends a separation unit at the discharge point, for example to recycle product residues. If required, waste gas (exhaust air) and waste water can be discharged separately.

FIG. 3 shows a comparison of the impulse flushing method according to the invention with an acceleration component and without an acceleration component. The wall shear stress is shown in relation to the average flow velocity. The flow velocity of the water blocks lies between 15 and 20 m/s for impulse flushing. By arranging the pre-run section upstream of the flushing section, an acceleration section is achieved so that the resulting acceleration component significantly increases the wall shear stress.

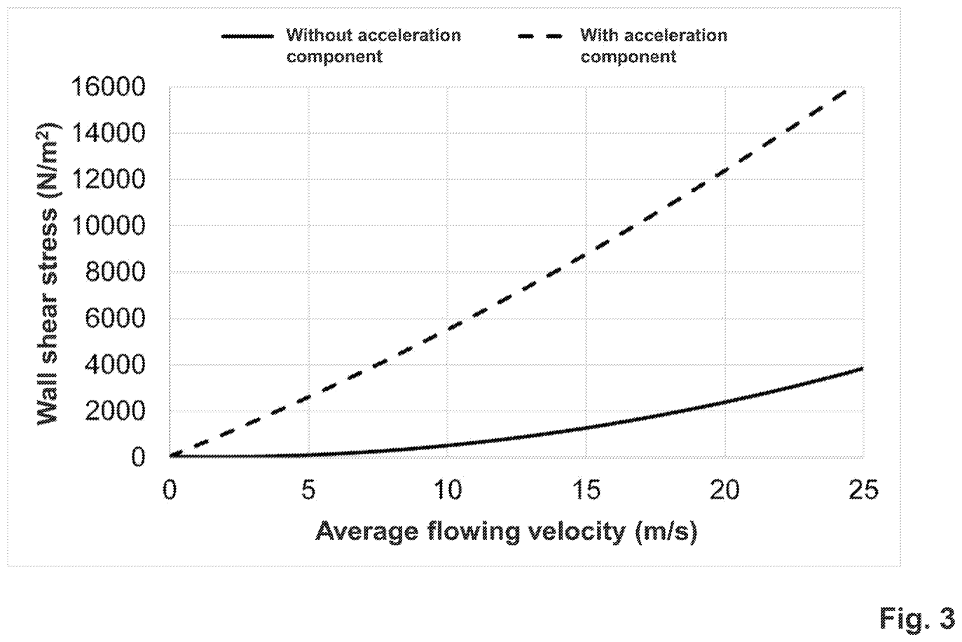

A decisive advantage of process-integrated cleaning is the significant saving of up to 95% in water requirements The reduced water requirement and cleaning time thus significantly reduce resource requirements and total costs. Tests have also shown that built-in components such as pumps can be cleaned efficiently. The pump could be completely freed from product residues.

FIG. 4 shows a schematic structure of a process-integrated device according to the invention, using the example of a dispersion plant. For each system, a flushing section I, II and III are determined, which can be disconnected from each other by valves. The feed point is always located upstream of the respective built-in component (e.g., the pump (1), the pigging station (2) or the filter (3)) of the corresponding flushing sections I to III. The discharge can take place via a collecting pipe and, if required, the flushing water can be processed. The control room is responsible for the control of the individual valves, determining the individual cleaning sections I, II and III. If required, forward and combined backward cleaning is also possible.

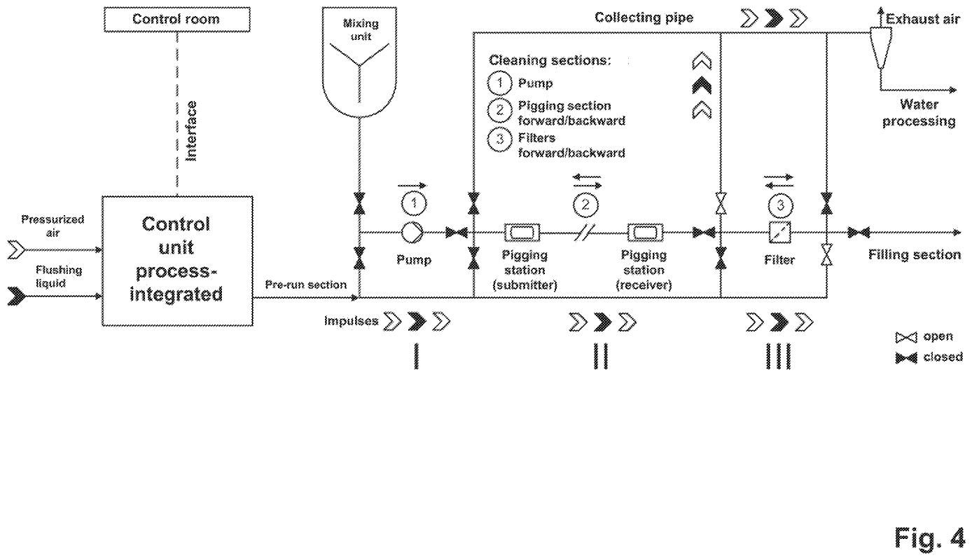

FIG. 5 shows the influence of the pre-run section on the cleaning success. The effectiveness of the cleaning builds up over the course of the pre-run section and is only fully developed at the beginning of the flushing section. Due to the arrangement of pre-run section upstream of the flushing section, which is used to accelerate the liquid blocks, the effectiveness of the cleaning is again significantly increased over the entire cleaning section compared to conventional impulse flushing without a pre-run section.

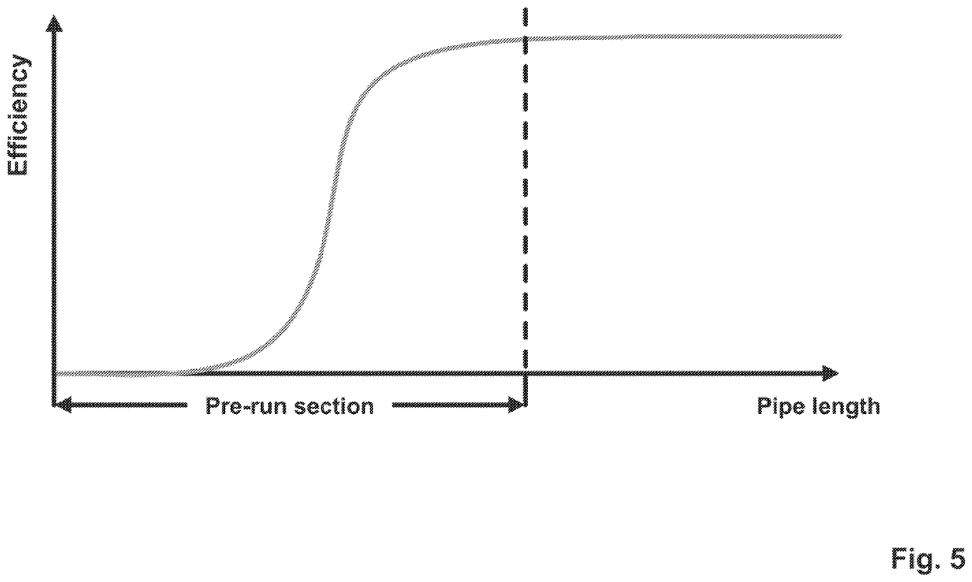

In summary, the process integration of the improved impulse flushing method enables permanently clean production facilities and geometry-independent cleaning of pipes, distributors, pumps, filters or fittings. Another decisive factor is the reduced water requirement and the resulting reduction in water volumes and recycling costs. In addition, it is possible to process the water or the use the fresh water. Process-integrated cleaning can also be fully automatic.

1. A method for cleaning pipes and systems by impinging modulating pressurized gas impulses to a pipe section partially filled with flushing liquid in order to develop alternating liquid blocks or gas blocks, which are driven in pulses along a flushing section from a feed point through the pipe to a discharge point in order to remove deposits on the pipe walls, characterized in that a pre-run section for accelerating the liquid volume within the pipe or system is provided upstream of the flushing section, with the pre-run section being partially filled with flushing liquid and in regard to its pipe geometry, pipe diameter and/or pipe length being dimensioned in a way that, when impinging a pressurized gas mixture, the liquid blocks in the pre-run section can completely develop in order to travel through the pipe diameter of the subsequent flushing section in a pipe-filling manner.

2. The method according to claim 1, characterized in that the pressurization of the pre-run section with the gas or gas mixture or the amount of flushing liquid can be adjusted in a way that the flushing liquid, which is driven by pulses in the pre-run section but still before the flushing section to a pipe-filling liquid block, can be accelerated to a velocity of at least 15 m/s.

3. The method according to claim 1, characterized in that at least a few segments of pre-run section are arranged upwards with an incline of >0° in relation to the horizontal level, whereby flushing liquid accumulates in the invert level of the partially filled pipe section.

4. The method according to claim 1, characterized in that the volume and length of the pre-run section are conditioned by the DN (nominal diameter) and topography of the subsequent flushing section.

5. The method according to claim 1, characterized in that the volume of the pre-run section is at least 10 times the pipe diameter of the flushing section.

6. The method according to claim 1, characterized in that the pre-run section is partially filled through precise control of the pressurized gas supply and flushing liquid supply, adjusting the volume flow, the amount and pressure.

7. The method according to claim 1, characterized in that the flushing section and thus the cleaning section are arranged according to the existing pipe topography or system topography, taking into account nominal values like geometry, length, diameter and/or dimension of individual pipe sections or build-in components of the system.

8. The method according to claim 6, characterized in that, in case of changes in the pipe or system, the affected pipe section or system section is disconnected from the flushing section.

9. The method according to one claim 1, characterized in that the pipes or systems to be cleaned are product pipes or systems of process facilities, with the cleaning of the pipe or system being carried out in a process-integrated or stationary manner as CIP (clean in place).

10. The method according to claim 9, characterized in that the pipe or system is divided into individual cleaning section, which can be disconnected from other pipe or system sections, depending on the DN (nominal diameters), with the disconnecting of cleaning sections being controlled by a control unit.

11. The method according to claim 1, characterized in that the systems to be cleaned are complex pipes, fittings, filters, pumps, sieves, distributors, vessels, reactors, hydrogenation plants and heat exchangers.

12. The method according to claim 1, characterized in that a separation unit is intended for the discharge point, which is configured in a way that flushing liquid, pressurized gas or product residues are separated from the flushing liquid of the cleaned pipe or cleaned system.

13. The method according to claim 12, with the flushing liquid of the separation unit separated from the product residues being transported back to the feed point.

14. A device for cleaning pipes and systems by impinging modulative pressurized gas impulses to a pipe section partially filled with flushing liquid in order to develop alternating liquid blocks or gas blocks, which are driven in pulses along a flushing section from a feed point through the pipe to a discharge point in order to remove deposits on the pipe walls, characterized in that a pre-run section for accelerating the liquid volume within the pipe or system is arranged upstream of the flushing section, with the pre-run section being partially filled with flushing liquid and in regard to its pipe geometry, pipe diameter and/or pipe length being dimensioned in a way that by impinging a pressurized gas mixture the liquid blocks within the pre-run section can be completely developed in order to travel through the pipe diameter of the subsequent flushing section in a pipe-filling manner.

15. The device according to claim 14, characterized in that at least segments of the pre-run section are arranged upwards with an incline of >0° in relation to the horizontal level.

16. The device according to claim 14, characterized in that the device is part of process facility, with a control unit being intended to carry out the cleaning in a semi-automatic or fully automatic process-integrated manner, with the pipe or system being divided into individual cleaning sections, which can be disconnected from other pipe or system sections, depending on the DN (nominal diameters), which, in turn, can be disconnected from one another through valves, stop-valves or fittings.
